(19) United States
(12) Patent Application Publication
(10) Pub. No.: US 2024/0072940 A1
(43) Pub. Date: Feb. 29, 2024

(54) METHOD AND APPARATUS FOR SENDING HYBRID AUTOMATIC REPEAT REQUEST FEEDBACK, DEVICE, AND MEDIUM

(71) Applicant: BEIJING XIAOMI MOBILE SOFTWARE CO., LTD., Beijing (CN)

(72) Inventor: Ting FU, Beijing (CN)

(73) Assignee: BEIJING XIAOMI MOBILE SOFTWARE CO., LTD., Beijing (CN)

(21) Appl. No.: 18/274,349

(22) PCT Filed: Jan. 26, 2021
(86) PCT No.: PCT/CN2021/073812

§ 371 Date: Jul. 26, 2023

(51) Int. Cl. H04L 1/1812; H04L 1/00; H04L 5/00

(52) U.S. Cl. CPC H04L 1/1812; H04L 1/0027; H04L 5/0053

(57) ABSTRACT

The present disclosure includes a method, apparatus, and storage medium for sending a hybrid automatic repeat request (HARQ) comprising an acknowledgement (ACK) or a negative acknowledgement (NACK) corresponding to an HARQ process group.

### CROSS-REFERENCE OF RELATED APPLICATION

The present application is a U.S. National Stage of International Application No. PCT/CN2021/073812, filed on Jan. 26, 2021, the disclosure of which is incorporated herein by reference in their entireties for all purposes.

### BACKGROUND

In the 5G network, the Sub-Carrier Space (SCS) in the frequency domain is variable. After 960 KHz SCS is used, the duration of corresponding time slot is 1/64 millisecond. Since the duration is short, the process duration of a Physical Downlink Shared Channel (PDSCH) will last for more time slots, and the corresponding Round-Trip Time (RTT) will span more time slots, for example, a RTT spans 64 time slots. The original 16 HARQ processes will not be able to support the use of 960 KHz SCS, so the system needs to support more parallel HARQ processes, such as 64 parallel HARQ processes, or 128 parallel HARQ process.

### SUMMARY

The present disclosure relates to the field of communications, and in particular, to a method, apparatus, and storage medium for sending HARQ feedback.

In a first example, the disclosure includes a method for sending a hybrid automatic repeat request HARQ feedback, applied to user equipment, the method comprising: sending a HARQ feedback corresponding to a HARQ process group, wherein the HARQ feedback corresponding to the HARQ process group includes an acknowledgement ACK or a negative acknowledgment NACK corresponding to the HARQ process group.

In a second example, the disclosure includes an apparatus for sending hybrid automatic repeat request HARQ feedback, applied to user equipment, the apparatus comprising: a sending module configured to send a HARQ feedback corresponding to a HARQ process group, wherein the HARQ feedback corresponding to the HARQ process group includes an acknowledgement ACK or a negative acknowledgment NACK corresponding to the HARQ process group.

In a third example the disclosure includes, user equipment comprising: a processor; and a memory for storing processor-executable instructions; where, the processor is configured to execute executable instructions in the memory to implement the steps of the method for sending hybrid automatic repeat request HARQ feedback.

In a fourth example, the disclosure includes a non-transitory computer-readable storage medium having executable instructions stored thereon, which implements the steps of the method for sending HARQ feedback for a hybrid automatic repeat request when executed by a processor.

It is to be understood that the foregoing general description and the following detailed description are exemplary only and should not be interpreted as limiting the present disclosure.

### BRIEF DESCRIPTION OF THE DRAWINGS

The accompanying drawings described herein are used to provide further understanding of the present disclosure. The drawings and their descriptions illustrate principles of the examples herein and should not be interpreted as limiting the scope of the present disclosure. In the accompany drawings:

FIG. 1 is a flowchart of a method for sending HARQ feedback according to one example of the present disclosure.

FIG. 2 is a flowchart of a method for sending HARQ feedback according to one example of the present disclosure.

FIG. 3 is a flowchart of a method for sending HARQ feedback according to one example of the present disclosure.

FIG. 4 is a flowchart of a method for sending HARQ feedback according to one example of the present disclosure.

FIG. 5 is a structural diagram of an apparatus for sending HARQ feedback according to one example of the present disclosure.

FIG. 6 is a structural diagram of an apparatus for sending HARQ feedback according to one example of the present disclosure.

FIG. 7 is a structural diagram of an apparatus for sending HARQ feedback according to one example of the present disclosure.

### DETAILED DESCRIPTION

Examples of the present disclosure are further described with reference to the accompanying drawings. The implementations described in the following examples are not intended to represent all implementations of the present disclosure. Rather, they are merely examples of methods, apparatus, and storage mediums consistent with some aspects of the present disclosure as recited in the appended claims.

The Type 3 HARQ-ACK codebook supports a feedback method in which the HARQ-ACK information of all HARQ processes is fed back all at once. For example, the base station configures 16 downlink HARQ processes for the user equipment. When the base station triggers the user equipment to use the type 3 HARQ-ACK feedback method, the user equipment needs to feed back the HARQ-ACK information of all 16 downlink HARQ processes at one time. After the number of HARQ processes is extended, for example, the number of extended HARQ processes is 64 or 128, in the Type 3 HARQ feedback method, if HARQ feedback is sent separately for each HARQ process, it will result in high information overhead for sending HARQ feedback.

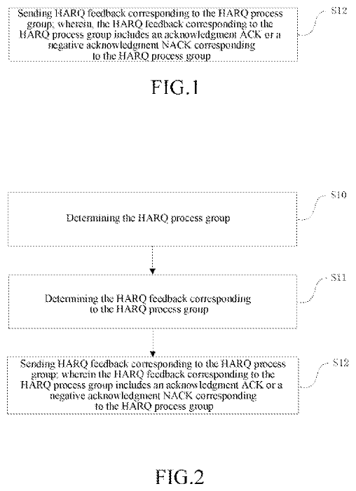

One example of the present disclosure provides a method, applied to user equipment, for sending hybrid automatic repeat request HARQ feedback. FIG. 1 is a flowchart of a method for sending HARQ feedback according to the example. As shown in FIG. 1, the method includes: at step S12, sending HARQ feedback corresponding to the HARQ process group. The HARQ feedback corresponding to the HARQ process group includes an acknowledgement ACK or a negative acknowledgment NACK corresponding to the HARQ process group.

The acknowledgement ACK (ACKnowledgement) indicates that the scheduled PDSCH demodulation is correct. Negative acknowledgment NACK (Negative ACKnowledgment) indicates that the scheduled PDSCH demodulation is wrong.

In one example, the number of HARQ processes included in each HARQ process group is greater than one.

In one example, the number of HARQ processes included in each HARQ process group is the same.

In one example, the number of HARQ processes included in each HARQ process group is four.

In one example, the number of HARQ processes included in each HARQ process group is 8.

In one example, the number of HARQ processes included in each HARQ process group is 16.

In one example, the number of HARQ processes included in each HARQ process group is 32.

In one example, there are at least two HARQ process groups, and the number of HARQ processes included in each HARQ process group in the at least two HARQ process groups is different.

In an example, the number of HARQ processes included in a part of the HARQ process groups is 4, and the number of HARQ processes included in the other part of the HARQ process groups is 8.

In an example, the number of HARQ processes is 64. The IDs of the 64 HARQ processes are 0, 1, 2, . . . , 63 in sequence. The numbers of HARQ processes corresponding to the HARQ process groups are 4 and 8.

In one example, the first HARQ process group includes 4 HARQ processes, specifically including 4 HARQ processes with IDs 0 to 3. The second HARQ process group includes 8 HARQ processes, specifically including 8 HARQ processes with IDs 4 to 11. The third HARQ process group includes 4 HARQ processes, specifically including 4 HARQ processes with IDs 12 to 15. The fourth HARQ process group includes 8 HARQ processes, specifically including 8 HARQ processes with IDs 16 to 23, and so on.

In one example, the number of HARQ process groups is 16. The number of HARQ processes included in each HARQ process group is 4. HARQ feedback corresponding to the HARQ process group is sent for each HARQ process group. Before dividing the 64 HARQ processes into 16 HARQ process groups, one HARQ feedback is sent for each HARQ process, which takes 64 bits to send HARQ feedback; after dividing the 64 HARQ processes into 16 HARQ process groups, one HARQ feedback is sent for each HARQ process group, which takes only 16 bits to send the HARQ feedback.

In one example of the present disclosure, the concept of HARQ process group is adopted, HARQ processes are divided into HARQ process groups, and HARQ feedback corresponding to the HARQ process group is sent for each HARQ process group, so that it is not necessary to send HARQ feedback for each HARQ process, thereby saving the overhead for sending the HARQ feedback and improving the utilization rate of radio resources.

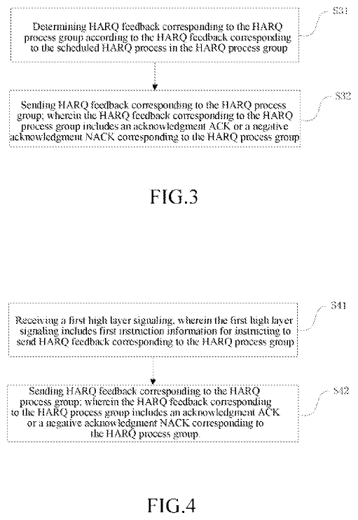

The present disclosure further provides a method for sending hybrid automatic repeat request HARQ feedback. The method is applied to user equipment. FIG. 2 is a flowchart of a method for sending HARQ feedback according to the example. As shown in FIG. 2, the method includes: at step S10, determining the HARQ process group; at step S11, determining the HARQ feedback corresponding to the HARQ process group; at step S12, sending HARQ feedback corresponding to the HARQ process group. The HARQ feedback corresponding to the HARQ process group includes an acknowledgement ACK or a negative acknowledgment NACK corresponding to the HARQ process group.

In one example, determining multiple HARQ process groups at step S10, includes: determining the number of HARQ processes constituting the HARQ process group, grouping HARQ processes according to the number, and determining at least one HARQ process group.

In one example, the number of HARQ processes constituting the HARQ process group is determined to be four. When the number of HARQ processes is 64, the 64 HARQ processes are divided into 16 HARQ process groups. The IDs of the 64 HARQ processes are 0, 1, 2, . . . , 63 in sequence. A first HARQ process group among the 16 HARQ process groups includes four HARQ processes with IDs 0 to 3. A second HARQ process group among the 16 HARQ process groups includes four HARQ processes with IDs 4 to 7, and so on.

In one example, a 16th HARQ process group among the 16 HARQ process groups includes four HARQ processes with IDs 60-63. In this example, before the 64 HARQ processes are divided into 16 HARQ process groups, one HARQ feedback is sent for each HARQ process, which takes 64 bits to send the HARQ feedback; and after the 64 HARQ processes are divided into 16 HARQ process groups, one HARQ feedback is sent for each HARQ process group, which takes only 16 bits to send the HARQ feedback.

In one example, determining the HARQ feedback corresponding to the HARQ process group at step S11 includes: in response to each HARQ process in the HARQ process group corresponding to an ACK, determining that the HARQ process group corresponds to an acknowledgement ACK. When determining the HARQ feedback corresponding to the HARQ process group, a logical AND method is used. When the HARQ feedbacks corresponding to all HARQ processes in the HARQ process group are acknowledgements ACKs, the HARQ feedback corresponding to the HARQ process group is determined as acknowledgement ACK.

In one example, determining the HARQ feedback corresponding to the HARQ process group at step S11 includes: in response to at least one HARQ process in the HARQ process group corresponding to NACK, determining that the HARQ process group corresponds to a negative acknowledgment NACK. In this example, when determining the HARQ feedback corresponding to the HARQ process group, the logical AND method is adopted, and when the HARQ feedback corresponding to at least one HARQ process in the HARQ process group is a negative acknowledgement NACK, the HARQ feedback corresponding to the HARQ process group is determined as negative acknowledgement NACK.

One example of the present disclosure provides a method for sending hybrid automatic repeat request HARQ feedback, and the method is applied to user equipment. This method includes: determining a HARQ process group; sending HARQ feedback corresponding to the HARQ process group. The HARQ feedback corresponding to the HARQ process group includes an acknowledgement ACK or a negative acknowledgment NACK corresponding to the HARQ process group.

The example of the present disclosure provides a method for sending hybrid automatic repeat request HARQ feedback, and the method is applied to user equipment. This method includes: determining HARQ feedback corresponding to the HARQ process group; sending HARQ feedback corresponding to the HARQ process group. The HARQ feedback corresponding to the HARQ process group includes an acknowledgement ACK or a negative acknowledgment NACK corresponding to the HARQ process group.

The example of the present disclosure provides a method for sending a hybrid automatic repeat request HARQ feedback, and the method is applied to user equipment. This method includes: in response to each HARQ process in the HARQ process group corresponding to ACK, sending ACK corresponding to the HARQ process group.

In one example of the present disclosure, when determining the HARQ feedback corresponding to the HARQ process group, the logical AND method is adopted, and when the HARQ feedbacks corresponding to all HARQ processes in the HARQ process group are acknowledgements ACKs, the HARQ feedback corresponding to the HARQ process group is determined as acknowledgement ACK, thereby saving information overhead for sending HARQ feedback, and improving the utilization rate of radio resources.

The example of the present disclosure provides a method for sending hybrid automatic repeat request HARQ feedback, and the method is applied to user equipment. This method includes: in response to at least one HARQ process in the HARQ process group corresponding to NACK, sending NACK corresponding to the HARQ process group.

In one example of the present disclosure, when determining the HARQ feedback corresponding to the HARQ process group, the logical AND method is adopted, and when the HARQ feedback corresponding to at least one HARQ process in the HARQ process group is a negative acknowledgement NACK, the HARQ feedback corresponding to the HARQ process group is determined as negative acknowledgement NACK, thereby saving the information overhead for sending HARQ feedback, and improving the utilization rate of radio resources.

The example of the present disclosure provides a method for sending hybrid automatic repeat request HARQ feedback, and the method is applied to user equipment. Referring to FIG. 3, FIG. 3 is a flowchart of a method for sending HARQ feedback according to one example. As shown in FIG. 3, the method includes: at step S31, determining HARQ feedback corresponding to the HARQ process group according to the HARQ feedback corresponding to the scheduled HARQ process in the HARQ process group; at step S32, sending HARQ feedback corresponding to the HARQ process group. The HARQ feedback corresponding to the HARQ process group includes an acknowledgement ACK or a negative acknowledgment NACK corresponding to the HARQ process group.

The unscheduled HARQ processes in the HARQ process group will affect the HARQ feedback of the HARQ process group. Specifically, the unscheduled HARQ processes in the HARQ process group have no actual scheduling data, and the HARQ feedback corresponding to the unscheduled HARQ processes is negative acknowledgement NACK or DTX. The negative acknowledgement NACK (Negative ACKnowledgment) indicates that the scheduled PDSCH is demodulated incorrectly, and the DTX indicates that the PDCCH corresponding to the scheduled PDSCH has not been received. When using the logical AND result of the HARQ feedback of each HARQ process in the HARQ process group as the HARQ feedback corresponding to the HARQ process group, if each HARQ process in the HARQ process group corresponds to ACK, then the HARQ process group corresponds to ACK, and if one or more HARQ processes in the HARQ process group correspond to NACK or DTX, then the HARQ process group corresponds to NACK. After the user equipment sends the NACK corresponding to the HARQ process group, it will cause retransmission of the scheduled HARQ process in the HARQ process group, thereby wasting radio resources.

For example, the HARQ process group includes 4 HARQ processes, and the IDs of the 4 HARQ processes are 0, 1, 2, and 3. The three HARQ processes with IDs 0, 1, and 2 have completed scheduling data, and the user equipment demodulates the scheduled PDSCH correctly, so the HARQ processes with IDs 0, 1, and 2 all correspond to ACK. The HARQ process with ID 3 has no scheduling data (that is, the HARQ process with ID 3 is not used when the base station schedules data), and the HARQ process with ID 3 corresponds to DTX or NACK. When the logical AND result of the HARQ feedbacks of HARQ processes in the HARQ process group is used as the HARQ feedback corresponding to the HARQ process group, the user equipment sends a NACK for this HARQ process group. This will result in unnecessary retransmissions of HARQ processes with IDs 0, 1, 2.

In one example of the present disclosure, the HARQ feedback corresponding to the HARQ process group is determined according to the HARQ feedback corresponding to the scheduled HARQ process in the HARQ process group, and the HARQ feedback corresponding to the unscheduled HARQ process is not considered, which can prevent the unscheduled HARQ process from causing the unnecessary retransmission of the scheduled HARQ process and improve the utilization rate of radio resources.

One example of the present disclosure provides a method for sending hybrid automatic repeat request HARQ feedback, and the method is applied to user equipment. This method includes: in response to each scheduled HARQ process in the HARQ process group corresponding to ACK, sending ACK corresponding to the HARQ process group.

One example of the present disclosure provides a method for sending hybrid automatic repeat request HARQ feedback, and the method is applied to user equipment. This method includes: in response to at least one scheduled HARQ process in the HARQ process group corresponding to NACK, sending NACK corresponding to the HARQ process group.

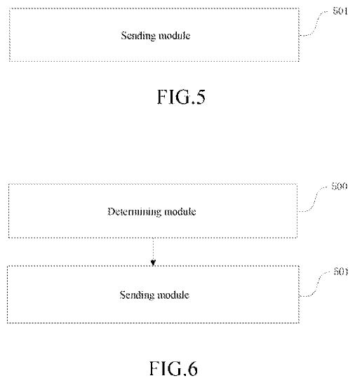

One example of the present disclosure provides a method for sending hybrid automatic repeat request HARQ feedback. The method is applied to user equipment. FIG. 4 is a flowchart of a method for sending HARQ feedback according to one example. As shown in FIG. 4, the method includes: at step S41, receiving a first high layer signaling, where the first high layer signaling includes first configuration information for configuring to send HARQ feedback corresponding to the HARQ process group; at step S42, sending HARQ feedback corresponding to the HARQ process group. The HARQ feedback corresponding to the HARQ process group includes an acknowledgement ACK or a negative acknowledgment NACK corresponding to the HARQ process group.

In one example, the first high layer signaling includes a first setting field, and the first setting field carries the first configuration information.

In one example of the present disclosure, the user equipment is instructed through high layer signaling that HARQ feedback needs to be sent by using the HARQ process group method. In response to this instruction, the user sends HARQ feedback corresponding to the HARQ process group, instead of sending the corresponding HARQ feedback for each HARQ process, thereby saving the information overhead for sending HARQ feedback and improving the utilization rate of radio resources.

One example of the present disclosure provides a method for sending hybrid automatic repeat request HARQ feedback, and the method is applied to user equipment. This method includes: when both the first high layer signaling and the second high layer signaling are received, sending HARQ feedback corresponding to the HARQ process group, and not sending acknowledgement ACK or negative acknowledgement NACK corresponding to the code block group.

The first high layer signaling includes first configuration information for configuring to send HARQ feedback corresponding to the HARQ process group, and the second high layer signaling includes second configuration information for configuring to send HARQ feedback corresponding to the code block group.

The HARQ feedback corresponding to the HARQ process group includes an acknowledgement ACK or a negative acknowledgment NACK corresponding to the HARQ process group.

In one example, the first high layer signaling includes a first setting field, and the first setting field carries the first configuration information.

In one example, the second high layer signaling includes a second setting field, and the second setting field carries the second configuration information.

In one example, the first high layer signaling and the second high layer signaling are the same high layer signaling.

In one example, the first high layer signaling and the second high layer signaling are different high layer signaling.

In one example of the present disclosure, when both HARQ process group method and code block group method are configured on the network side to send HARQ feedback, the configuration of sending HARQ feedback by adopting code block group method is ignored, and only the HARQ feedback corresponding to the HARQ process group is sent, thereby preventing the conflict between the two configurations.

The present disclosure further provides for a method for sending hybrid automatic repeat request HARQ feedback. The method is applied to user equipment. The method includes: receiving a first high layer signaling, where the first high layer signaling includes first configuration information for configuring to send HARQ feedback corresponding to the HARQ process group, and receiving a second high layer signaling, where the second high layer signaling includes second configuration information for configuring to send HARQ feedback corresponding to the code block group.

When both the first high layer signaling and the second high layer signaling are received, HARQ feedback corresponding to the HARQ process group is sent, and the second configuration information for configuring to send the HARQ feedback corresponding to the code block group is ignored.

The first high layer signaling includes first configuration information for configuring to send HARQ feedback corresponding to the HARQ process group, and the second high layer signaling includes second configuration information for configuring to send HARQ feedback corresponding to the code block group.

The HARQ feedback corresponding to the HARQ process group includes an acknowledgement ACK or a negative acknowledgment NACK corresponding to the HARQ process group.

In one example, the first high layer signaling includes a first setting field, and the first setting field carries the first configuration information.

In one example, the second high layer signaling includes a second setting field, and the second setting field carries the second configuration information.

In one example, the first high layer signaling and the second high layer signaling are the same high layer signaling.

In one example, the first high layer signaling and the second high layer signaling are different high layer signaling.

In one example of the present disclosure, when both HARQ process group method and code block group method is configured on the network side to send HARQ feedback, the configuration of sending HARQ feedback by adopting code block group method is ignored, and only HARQ feedback corresponding to the HARQ process group is sent, thereby preventing the conflict between the two configurations.

One example of the present disclosure includes a method for sending hybrid automatic repeat request HARQ feedback. The method is applied to user equipment. This method includes: receiving a first high-layer signaling, where the first high-layer signaling includes first configuration information for configuring to send HARQ feedback corresponding to the HARQ process group, and third configuration information for configuring the number of HARQ processes in the HARQ process group; sending HARQ feedback corresponding to the HARQ process group. The HARQ feedback corresponding to the HARQ process group includes an acknowledgement ACK or a negative acknowledgment NACK corresponding to the HARQ process group.

In one example, the first high layer signaling includes a first setting field, and the first setting field carries the first configuration information. The first high layer signaling includes a third setting field, and the first setting field carries the third configuration information.

In one example, the third configuration information is used to configure the number of HARQ processes in the HARQ process group. The user equipment determines HARQ process groups by grouping the HARQ processes according to this number. The number of HARQ processes included in each HARQ process group is the same, and is the number configured in the third configuration information.

For example: the specific value of the number of HARQ processes in the HARQ process group instructed by the third configuration information is 4. When the number of HARQ processes is 64, the user equipment divides the 64 HARQ processes into 16 HARQ process groups, and each HARQ process group includes 4 HARQ processes. The IDs of the 64 HARQ processes are 0, 1, 2, . . . , 63 in sequence. The first HARQ process group among the 16 HARQ process groups includes four HARQ processes with IDs 0 to 3. The second HARQ process group among the 16 HARQ process groups includes four HARQ processes with IDs 4 to 7, and so on. The 16th HARQ process group among the 16 HARQ process groups includes four HARQ processes with IDs 60-63.

In one example, the third configuration information is used to configure a first value and a second value. The first value is the number of HARQ processes in the first-type HARQ process group, and the second value is the number of HARQ processes in the second-type HARQ process group. The user equipment groups the HARQ processes according to the first value and the second value, and determines the first-type HARQ process group and the second-type HARQ process group, and the number of HARQ processes included in the first-type HARQ process group is the first value; the number of HARQ processes included in the second-type HARQ process group is the second value.

In one example, the third configuration information is used to instruct a first value, a second value and a third value. The first value is the number of HARQ processes in the first-type HARQ process group, the second value is the number of HARQ processes in the second-type HARQ process group, and the third value is used to instruct the manner of dividing the first-type HARQ process group and the second-type HARQ process group.

For example: when the third value is 0, it means that all HARQ processes are equally divided into two parts. A first part of HARQ processes are divided into multiple first-type HARQ process groups, and a second part of HARQ processes are divided into multiple second-type HARQ process groups. The number of HARQ processes is 64. The IDs of the 64 HARQ processes are 0, 1, 2, . . . , 63 in sequence. Among the specific values configured by the third configuration information, the first value is 4, the second value is 8, and the third value is 0. The user equipment determines that the first part of HARQ processes include HARQ processes with IDs 0 to 31, and the second part of HARQ processes include HARQ processes with IDs 32 to 63. The first part of HARQ processes are divided into 8 HARQ process groups, and each HARQ process group includes 4 HARQ processes, wherein the first HARQ process group includes 4 HARQ processes with IDs 0 to 3, and the second HARQ process group includes 4 HARQ processes with IDs 4 to 7, and so on, and the 8th HARQ process group includes 4 HARQ processes with IDs 28 to 31. The second part of HARQ processes are divided into 4 HARQ process groups, and each HARQ process group includes 8 HARQ processes, wherein the first HARQ process group includes 8 HARQ processes with IDs 32 to 39, and the second HARQ process group includes 8 HARQ processes with IDs 40 to 47, and so on, and the fourth HARQ process group includes 8 HARQ processes with IDs 56 to 63.

In another example: when the third value is 1, it means that all HARQ processes are divided into alternately arranged first-type HARQ process groups and second-type HARQ process groups. The number of HARQ processes is 64. The IDs of the 64 HARQ processes are 0, 1, 2, . . . , 63 in sequence. As configured by the third configuration information, the first value is 4, the second value is 8, and the third value is 1. The first HARQ process group includes 4 HARQ processes with IDs 0 to 3. The second HARQ process group includes 8 HARQ processes with IDs 4 to 11. The third HARQ process group includes 4 HARQ processes with IDs 12 to 15. The 4th HARQ process group includes 8 HARQ processes with IDs 16 to 23, so on and so forth . . . . The 11th HARQ process group includes 4 HARQ processes with IDs 52 to 55. The 12th HARQ process group includes 8 HARQ processes with IDs 56 to 63.

In the present disclosure, the user equipment is instructed through high layer signaling that the HARQ feedback needs to be sent by adopting the HARQ process group method, and the number of HARQ processes in the HARQ process group is configured. The user equipment determines the HARQ process group according to the number configured on the network side, and in respond to this instruction, the HARQ feedback corresponding to the HARQ process group is sent instead of sending the corresponding HARQ feedback for each HARQ process, thereby saving the information overhead for sending the HARQ feedback and improving the utilization rate of radio resources.

The present disclosure provides a method for sending hybrid automatic repeat request HARQ feedback, and the method is applied to user equipment. This method includes: receiving a third high layer signaling, where the third high layer signaling includes third configuration information for configuring the number of HARQ processes in the HARQ process group; sending HARQ feedback corresponding to the HARQ process group. The HARQ feedback corresponding to the HARQ process group includes an acknowledgement ACK or a negative acknowledgment NACK corresponding to the HARQ process group.

The network side configures the number of HARQ processes in the HARQ process group. When the user equipment learns this configuration, it determines that the network side device instructs the user equipment by default to send HARQ feedback by adopting the HARQ process group method.

In one example, the method includes: receiving a third high layer signaling, where the third high layer signaling includes third configuration information for configuring the number of HARQ processes in the HARQ process group; determining one or more HARQ process groups by grouping the HARQ processes according to the number of HARQ processes in the HARQ process group; determining the HARQ feedback corresponding to the HARQ process group; sending HARQ feedback corresponding to the HARQ process group. The HARQ feedback corresponding to the HARQ process group includes an acknowledgement ACK or a negative acknowledgment NACK corresponding to the HARQ process group. The network side configures the number of HARQ processes in the HARQ process group. The user equipment determines the HARQ process group according to the number configured on the network side, and determines that the network side device instructs the user equipment by default to send HARQ feedback by adopting the HARQ process group method.

In another example, the method includes: receiving a third high layer signaling, where the third high layer signaling includes third configuration information for configuring the number of HARQ processes in the HARQ process group; determining one or more HARQ process groups by grouping the HARQ processes according to the number of HARQ processes in the HARQ process group; sending HARQ feedback corresponding to the HARQ process group. The HARQ feedback corresponding to the HARQ process group includes an acknowledgement ACK or a negative acknowledgment NACK corresponding to the HARQ process group. The network side configures the number of HARQ processes in the HARQ process group. The user equipment determines the HARQ process group according to the number configured on the network side, and determines that the network side device instructs the user equipment by default to send HARQ feedback by adopting the HARQ process group method.

One example of the present disclosure provides an apparatus for sending hybrid automatic repeat request HARQ feedback, and the apparatus is applied to user equipment. This apparatus is used to perform the method of sending HARQ feedback in any of the above-mentioned examples. Referring to FIG. 5, FIG. 5 is a structural diagram of an apparatus for sending HARQ feedback according to one example. As shown in FIG. 5, the apparatus includes: a sending module 501 configured to send HARQ feedback corresponding to the HARQ process group, wherein the HARQ feedback corresponding to the HARQ process group includes an acknowledgement ACK or a negative acknowledgment NACK corresponding to the HARQ process group.

In another example, the apparatus includes: a sending module 501 configured to, in response to each HARQ process in the HARQ process group corresponding to ACK, send ACK corresponding to the HARQ process group.

In one example, the apparatus includes: a sending module 501 configured to, in response to at least one HARQ process in the HARQ process group corresponding to NACK, send NACK corresponding to the HARQ process group.

In one example, the apparatus includes: a sending module 501 configured to, in response to each scheduled HARQ process in the HARQ process group corresponding to ACK, send ACK corresponding to the HARQ process group.

In one example, the apparatus includes: a sending module 501 configured to, in response to at least one scheduled HARQ process in the HARQ process group corresponding to NACK, send NACK corresponding to the HARQ process group.

Referring to FIG. 6, FIG. 6 is a structural diagram of an apparatus for sending HARQ feedback according to one example. As shown in FIG. 6, the apparatus includes: a determining module 500 configured to determine the HARQ feedback corresponding to the HARQ process group according to the HARQ feedback corresponding to the scheduled HARQ process in the HARQ process group; a sending module 501 configured to send ACK corresponding to the HARQ process group in response to each scheduled HARQ process in the HARQ process group corresponding to ACK.

As shown in FIG. 6, the apparatus includes: a determining module 500 configured to determine the HARQ feedback corresponding to the HARQ process group according to the HARQ feedback corresponding to the scheduled HARQ process in the HARQ process group; a sending module 501 configured to, in response to at least one scheduled HARQ process in the HARQ process group corresponding to NACK, send NACK corresponding to the HARQ process group.

In one example, the apparatus includes: a first receiving module configured to receive first high layer signaling, where the first high layer signaling includes first configuration information for configuring to send HARQ feedback corresponding to the HARQ process group; a sending module 501 configured to send HARQ feedback corresponding to the HARQ process group, wherein the HARQ feedback corresponding to the HARQ process group includes an acknowledgement ACK or a negative acknowledgment NACK corresponding to the HARQ process group.

The apparatus can further include: a second receiving module configured to receive a first high layer signaling, where the first high layer signaling includes first configuration information for configuring to send HARQ feedback corresponding to the HARQ process group, and to receive a second high layer signaling, where the second high layer signaling includes second configuration information for configuring to send HARQ feedback corresponding to the code block group; a processing module configured not to sending ACK or NACK corresponding to the code block group when the second receiving module receives both the first high-layer signaling and the second high-layer signaling; a sending module 501 configured to send HARQ feedback corresponding to the HARQ process group, wherein the HARQ feedback corresponding to the HARQ process group includes an acknowledgement ACK or a negative acknowledgment NACK corresponding to the HARQ process group.

In one example, the apparatus includes: a first receiving module configured to receive first high-layer signaling, where the first high layer signaling includes first configuration information for configuring to send HARQ feedback corresponding to the HARQ process group, and third configuration information for configuring the number of HARQ processes in the HARQ process group; a sending module 501 configured to send HARQ feedback corresponding to the HARQ process group, wherein the HARQ feedback corresponding to the HARQ process group includes an acknowledgement ACK or a negative acknowledgment NACK corresponding to the HARQ process group.

In one example, the apparatus further includes: a third receiving module configured to receive a third high layer signaling, where the third-layer signaling includes third configuration information for configuring the number of HARQ processes in the HARQ process group; a sending module 501 configured to send HARQ feedback corresponding to the HARQ process group, wherein the HARQ feedback corresponding to the HARQ process group includes an acknowledgement ACK or a negative acknowledgment NACK corresponding to the HARQ process group. The third configuration information can be used to configure a first value, a second value and a third value.

The first value is the number of HARQ processes in the first-type HARQ process group, the second value is the number of HARQ processes in the second-type HARQ process group, and the third value is used to instruct the manner of dividing the first-type HARQ process group and the second-type HARQ process group.

The disclosure includes user equipment, comprising: a processor; a memory for storing processor-executable instructions; wherein, the processor is configured to execute the executable instructions in the memory to implement the method of sending hybrid automatic repeat request HARQ feedback. The disclosure also includes a non-transitory computer-readable storage medium, which stores executable instructions, and when the executable instructions are executed by a processor, the steps of the method for sending hybrid automatic repeat request HARQ feedback are implemented.

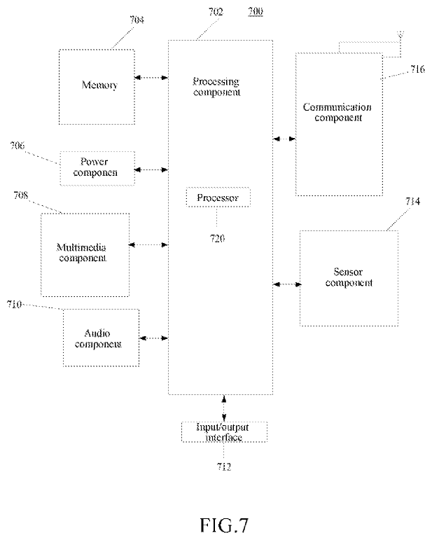

FIG. 7 is a block diagram of an apparatus 700 for sending hybrid automatic repeat request HARQ feedback according to one example. For example, apparatus 700 may be a mobile phone, computer, digital broadcasting terminal, messaging device, game console, tablet device, medical device, fitness device, personal digital assistant, and the like.

Referring to FIG. 7, the apparatus 700 may include one or more of the following components: a processing component 702, a memory 704, a power component 706, a multimedia component 708, an audio component 710, an input/output (I/O) interface 712, a sensor component 714, and communication component 716.

The processing component 702 generally controls the overall operation of the device 700, such as operations associated with display, phone calls, data communications, camera operations, and recording operations. The processing component 702 can include one or more processors 720 to execute instructions to perform all or some of the steps of the methods described above. Additionally, processing component 702 may include one or more modules to facilitate interaction between processing component 702 and other components. For example, processing component 702 may include a multimedia module to facilitate interaction between multimedia component 708 and processing component 702.

Memory 704 is configured to store various types of data to support operation at device 700. Examples of such data include instructions for any application or method operating on device 700, contact data, phonebook data, messages, pictures, videos, and the like. Memory 704 may be implemented by any type of volatile or nonvolatile storage device or combination thereof, such as static random access memory (SRAM), electrically erasable programmable read only memory (EEPROM), erasable Programmable Read Only Memory (EPROM), Programmable Read Only Memory (PROM), Read Only Memory (ROM), Magnetic Memory, Flash Memory, Magnetic or Optical Disk.

Power component 706 provides power to various components of device 700. Power components 706 may include a power management system, one or more power sources, and other components associated with generating, managing, and distributing power to device 700.

Multimedia component 708 includes screens that provide an output interface between the device 700 and the user. In some examples, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some examples, the multimedia component 708 includes a front-facing camera and/or a rear-facing camera. When the device 700 is in an operation mode, such as a shooting mode or a video mode, the front camera and/or the rear camera may receive external multimedia data. Each of the front and rear cameras can be a fixed optical lens system or have focal length and optical zoom capability.

Audio component 710 is configured to output and/or input audio signals. For example, audio component 710 includes a microphone (MIC) that is configured to receive external audio signals when device 700 is in operating modes, such as calling mode, recording mode, and voice recognition mode. The received audio signal may be further stored in memory 704 or transmitted via communication component 716. In some examples, audio component 710 also includes a speaker for outputting audio signals.

The I/O interface 712 provides an interface between the processing component 702 and a peripheral interface module, and the peripheral interface module may be a keyboard, a click wheel, a button, or the like. These buttons may include, but are not limited to: home button, volume buttons, start button, and lock button.

Sensor assembly 714 includes one or more sensors for providing status assessment of various aspects of device 700. For example, the sensor assembly 714 can detect the open/closed state of the device 700, the relative positioning of components, such as the display and keypad of the device 700, and the sensor assembly 714 can also detect a change in the position of the device 700 or a component of the device 700, the presence or absence of user contact with the device 700, the orientation or acceleration/deceleration of the device 700 and the temperature change of the device 700. Sensor assembly 714 may include a proximity sensor configured to detect the presence of nearby objects in the absence of any physical contact. Sensor assembly 714 may also include a light sensor, such as a CMOS or CCD image sensor, for use in imaging applications. In some examples, the sensor assembly 714 may also include an acceleration sensor, a gyroscope sensor, a magnetic sensor, a pressure sensor, or a temperature sensor.

Communication component 716 is configured to facilitate wired or wireless communication between apparatus 700 and other devices. Device 700 may access wireless networks based on communication standards, such as WiFi, 2G or 3G, or a combination thereof. In one example, the communication component 716 receives broadcast signals or broadcast related information from an external broadcast management system via a broadcast channel. In one example, the communication component 716 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In one example, apparatus 700 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component to perform the above method.

The examples can also include a non-transitory computer-readable storage medium comprising instructions, such as a memory 704 including instructions, executable by the processor 720 of the apparatus 700 to perform the method described above. For example, the non-transitory computer-readable storage medium may be ROM, random access memory (RAM), CD-ROM, magnetic tape, floppy disk, optical data storage device, and the like.

Other implementations of the disclosed examples will readily occur to those skilled in the art upon consideration of the specification and practice of the invention disclosed herein. This application is intended to cover any variations, uses, or adaptations of the disclosed examples that follow the general principles of the disclosed examples and include common general knowledge in the art not disclosed by the present disclosure or conventional technical means. The specification and examples are to be regarded as exemplary only, with the true scope and spirit of examples of the present disclosure being indicated by the following claims.

It should be understood that the examples of the present disclosure are not limited to the precise structures described above and illustrated in the accompanying drawings and that various modifications and changes may be made without departing from the scope thereof.

1. A method for sending hybrid automatic repeat request HARQ feedback, applied to user equipment, comprising:
sending a HARQ feedback corresponding to a HARQ process group, wherein the HARQ feedback corresponding to the HARQ process group comprises an acknowledgement ACK or a negative acknowledgement NACK corresponding to the HARQ process group.

2. The method for sending HARQ feedback according to claim 1, wherein sending the HARQ feedback corresponding to the HARQ process group comprises:
in response to each HARQ process in the HARQ process group corresponding to the ACK, sending the ACK corresponding to the HARQ process group.

3. The method for sending HARQ feedback according to claim 1, wherein sending the HARQ feedback corresponding to the HARQ process group comprises:
in response to at least one HARQ process in the HARQ process group corresponding to the NACK, sending the NACK corresponding to the HARQ process group.

4. The method for sending HARQ feedback according to claim 1, further comprising:
determining the HARQ feedback corresponding to the HARQ process group according to a HARQ feedback corresponding to a scheduled HARQ process in the HARQ process group.

5. The method for sending HARQ feedback according to claim 1, wherein sending the HARQ feedback corresponding to the HARQ process group comprises:
in response to each scheduled HARQ process in the HARQ process group corresponding to the ACK, sending the ACK corresponding to the HARQ process group.

6. The method for sending HARQ feedback according to claim 1, wherein sending the HARQ feedback corresponding to the HARQ process group comprises:
in response to at least one scheduled HARQ process in the HARQ process group corresponding to the NACK, sending the NACK corresponding to the HARQ process group.

7. The method for sending HARQ feedback according to claim 1, further comprising:
receiving a first high layer signaling, wherein the first high layer signaling comprises first configuration information for configuring to send the HARQ feedback corresponding to the HARQ process group.

8. The method for sending HARQ feedback according to claim 1, further comprising:
in response to that both a first high layer signaling and a second high layer signaling are received, not sending an acknowledgment ACK or a negative acknowledgment NACK corresponding to a code block group;
wherein, the first high layer signaling comprises first configuration information for configuring to send the HARQ feedback corresponding to the HARQ process group, and the second high layer signaling comprises second configuration information for configuring to send a HARQ feedback corresponding to the code block group.

9. The method for sending HARQ feedback according to claim 1, further comprising:
receiving a first high layer signaling, wherein the first high layer signaling comprises first configuration information for configuring to send the HARQ feedback corresponding to the HARQ process group, and third configuration information for configuring a number of HARQ processes in the HARQ process group; or,
receiving a third high layer signaling, wherein the third high layer signaling comprises third configuration information for configuring a number of HARQ processes in the HARQ process group.

10. The method for sending HARQ feedback according to claim 9, wherein,
the third configuration information is used to configure a first value, a second value and a third value;
wherein, the first value is a number of HARQ processes in a first-type HARQ process group, the second value is a number of HARQ processes in a second-type HARQ process group, and the third value is used to configure a manner of dividing the first-type HARQ process group and the second-type HARQ process group.

11-20. (canceled)

21. A user equipment comprising:
a processor; and
a memory for storing processor-executable instructions;
wherein the processor is configured to execute executable instructions in the memory to:
send a HARQ feedback corresponding to a HARQ process group, wherein the HARQ feedback corresponding to the HARQ process group comprises an acknowledgement ACK or a negative acknowledgement NACK corresponding to the HARQ process group.

22. A non-transitory computer-readable storage medium comprising executable instructions stored thereon that when executed cause a processor to implement:
sending a HARQ feedback corresponding to a HARQ process group, wherein the HARQ feedback corresponding to the HARQ process group comprises an acknowledgement ACK or a negative acknowledgement NACK corresponding to the HARQ process group.

23. The non-transitory computer-readable storage medium according to claim 22, wherein sending the HARQ feedback corresponding to the HARQ process group comprises:
in response to each HARQ process in the HARQ process group corresponding to the ACK, sending the ACK corresponding to the HARQ process group.

24. The non-transitory computer-readable storage medium according to claim 22, wherein sending the HARQ feedback corresponding to the HARQ process group comprises:
in response to at least one HARQ process in the HARQ process group corresponding to the NACK, sending the NACK corresponding to the HARQ process group.

25. The non-transitory computer-readable storage medium according to claim 22, wherein, the processor is further configured to implement:
determining the HARQ feedback corresponding to the HARQ process group according to a HARQ feedback corresponding to a scheduled HARQ process in the HARQ process group.

26. The non-transitory computer-readable storage medium according to claim 22, wherein sending the HARQ feedback corresponding to the HARQ process group comprises:
in response to each scheduled HARQ process in the HARQ process group corresponding to the ACK, sending the ACK corresponding to the HARQ process group.

27. The non-transitory computer-readable storage medium according to claim 22, wherein sending the HARQ feedback corresponding to the HARQ process group comprises:
in response to at least one scheduled HARQ process in the HARQ process group corresponding to the NACK, sending the NACK corresponding to the HARQ process group.

28. The non-transitory computer-readable storage medium according to claim 22, wherein, the processor is further configured to implement:
receiving a first high layer signaling, wherein the first high layer signaling comprises first configuration information for configuring to send the HARQ feedback corresponding to the HARQ process group.

29. The non-transitory computer-readable storage medium according to claim 22, wherein, the processor is further configured to implement:
in response to that both a first high layer signaling and a second high layer signaling are received, not sending an acknowledgement ACK or a negative acknowledgment NACK corresponding to a code block group;
wherein, the first high layer signaling comprises first configuration information for configuring to send the HARQ feedback corresponding to the HARQ process group, and the second high layer signaling comprises second configuration information for configuring to send a HARQ feedback corresponding to the code block group.

30. The non-transitory computer-readable storage medium according to claim 22, wherein, the processor is further configured to implement:
receiving a first high layer signaling, wherein the first high layer signaling comprises first configuration information for configuring to send the HARQ feedback corresponding to the HARQ process group, and third configuration information for configuring a number of HARQ processes in the HARQ process group; or,
receiving a third high layer signaling, wherein the third high layer signaling comprises third configuration information for configuring a number of HARQ processes in the HARQ process group.
